(19) United States
(12) Patent Application Publication
(10) Pub. No.: US 2018/0318493 A1
(43) Pub. Date: Nov. 8, 2018

(54) NOZZLE

(71) Applicant: Mikhail Domnine, Allentown, PA (US)

(72) Inventor: Mikhail Domnine, Allentown, PA (US)

(21) Appl. No.: 15/585,841

(22) Filed: May 3, 2017

(51) Int. Cl. A61M 3/02; B05B 1/14

(52) U.S. Cl. CPC A61M 3/0279; A61M 2205/586; A61M 3/0233; B05B 1/14

(57) ABSTRACT

An improved nozzle includes a nozzle body having a conical portion and a lower portion. The nozzle is used for irrigating nasal cavities and sinuses. Passageways for fluid are disposed in the conical portion, and fluting is provided on the lower portion to facilitate manual grasping. In one embodiment, each of the passageways is formed as a bore having a central axis aligned at a specific angle to a centerline of the nozzle body. In one embodiment, the passageways are evenly spaced about the central axis, and the specific angle is at 45 degrees.

### CROSS REFERENCE TO RELATED APPLICATIONS

Not applicable.

### STATEMENT REGARDING FEDERALLY SPONSORED RESEARCH OR DEVELOPMENT

Not applicable.

### FIELD OF THE INVENTION

The present invention relates to an improved nozzle for irrigation of nasal cavities and sinuses.

### BACKGROUND OF THE INVENTION

It is a problem in the art to provide nozzles for use in medicine. Many such nozzles are known.

More specifically, it is a problem in the art to provide a nozzle for irrigation of nasal cavities and sinuses.

### SUMMARY OF THE INVENTION

From the foregoing, it is seen that it is a problem in the art to provide a device meeting the above requirements. According to the present invention, a device is provided which meets the aforementioned requirements and needs in the prior art. Specifically, the device according to the present invention provides an improved nozzle for irrigation of nasal cavities and sinuses.

More specifically, the improved nozzle of the present invention includes a nozzle body having a conical portion and a lower portion, wherein passageways for fluid are disposed in the conical portion, and wherein fluting is provided on the lower portion to facilitate manual grasping.

In one embodiment, the passageways have an expanding set of surfaces. Each passageway includes convex first portions, convex second portions, and curved side portions which slope slightly outward from the center of each passage.

In a further embodiment, the nozzle includes a nozzle body having a conical portion and a lower portion, wherein passageways for fluid are disposed in the conical portion, and wherein fluting is provided on the lower portion to facilitate manual grasping. In this embodiment, each of the passageways is formed as a bore having a central axis aligned at a specific angle to a centerline of the nozzle body. In the preferred embodment, the specific angle is about 45 degrees.

Other objects and advantages of the present invention will be more readily apparent from the following detailed description when read in conjunction with the accompanying drawings.

### BRIEF DESCRIPTION OF THE DRAWINGS

FIG. 1 is a frontal perspective view of an improved nozzle, according to the present invention.

FIG. 2 is a rear perspective view of the improved nozzle of FIG. 1.

FIG. 3 is another frontal perspective view of the nozzle of FIG. 1, as viewed from below and to the left of FIG. 1.

FIG. 4 is another rear perspective view of the nozzle of FIG. 2, as viewed from the right and above FIG. 2.

FIG. 5 is an enlarged sectional view, partially broken away, showing one of the nozzle openings.

FIG. 6 is an enlarged view, partially broken away, showing the nozzle opening of FIG. 5.

FIG. 7 is a side elevational view of the improved nozzle of FIG. 1.

FIG. 8 is a sectional view taken along a vertical centerline of the nozzle of FIG. 2.

FIG. 9 is a top elevational view of the improved nozzle of FIG. 1.

FIG. 10 is a bottom elevational view of the improved nozzle of FIG. 1.

### DETAILED DESCRIPTION OF THE INVENTION

FIG. 1 is a frontal perspective view of an improved nozzle 100, according to the present invention. The elements shown in the drawings are discussed in detail further below.

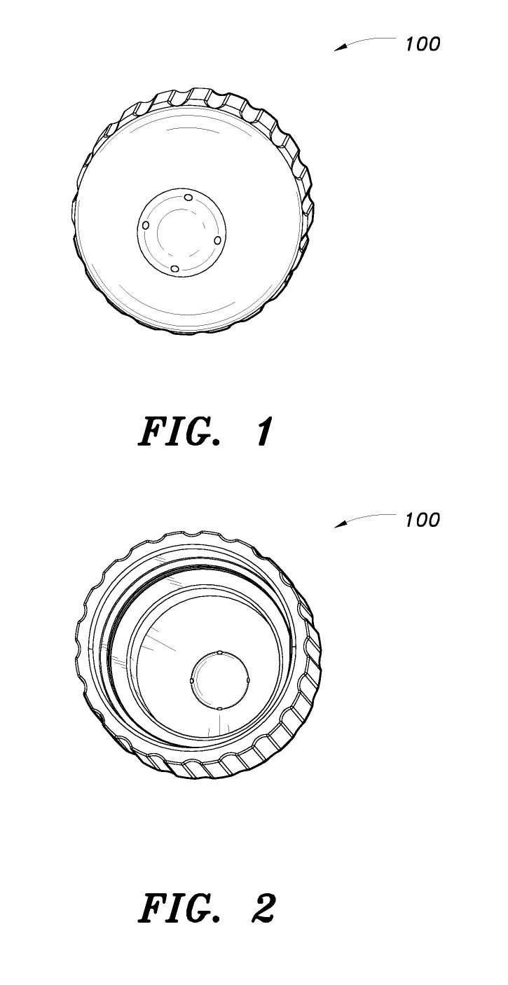

FIG. 2 is a rear perspective view of the improved nozzle 100 of FIG. 1.

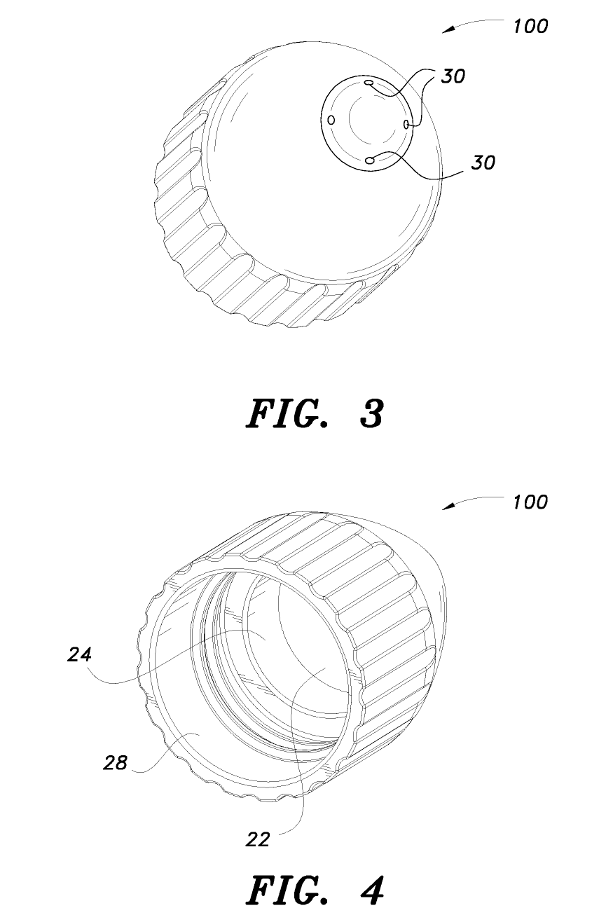

FIG. 3 is another frontal perspective view of the nozzle 100 of FIG. 1, as viewed from below and to the left of FIG. 1.

FIG. 4 is another rear perspective view of the nozzle 100 of FIG. 2, as viewed from the right and above FIG. 2.

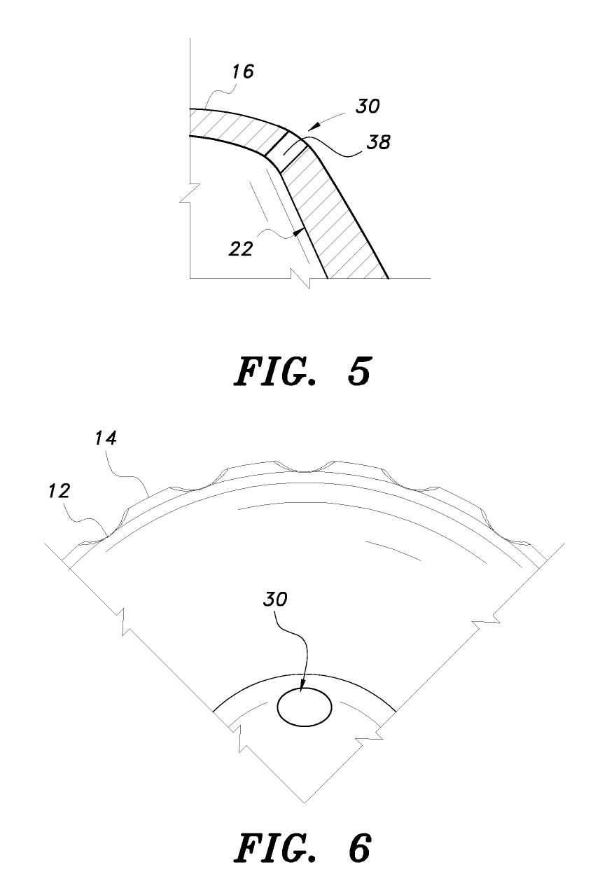

FIG. 5 is an enlarged sectional view, partially broken away, showing one of the nozzle openings 30.

FIG. 6 is an enlarged view, partially broken away, showing the nozzle opening 30 of FIG. 5.

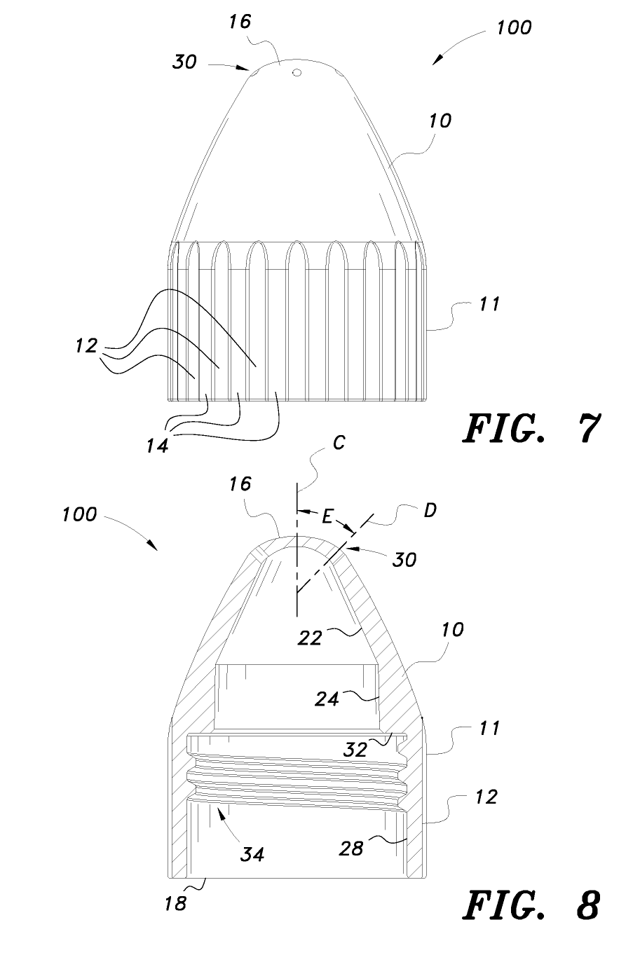

FIG. 7 is a side elevational view of the improved nozzle 100 of FIG. 1.

FIG. 8 is a sectional view taken along a vertical centerline of the nozzle 100 of FIG. 2.

As shown in FIGS. 1-8, the nozzle 100 includes a conical portion 10, a fluted lower portion 11, a bottom edge 18, and a tip 16 having four passages 30 therein. An enlarged view of one of the passages 30, is shown in FIG. 5 in section and partially broken away, showing the interior passage wall 38. As shown in FIG. 7, the lower portion 11 is fluted by having a plurality of vertically aligned recesses 12 evenly spaced along a periphery thereof, and a plurality of vertically aligned raised portions 14 respectively disposed between the recesses 12.

As shown in FIG. 4, the nozzle 100 has a generally conical inner surface 22 inside the conical portion 10. The surface 22 extends to meet a generally cyclindrical first inner surface 24, and a lower expanded portion containing threading 34 (unnumbered in FIG. 4, and shown numbered in FIG. 8), the lower expanded portion having a generally cyclindrical second inner surface 28 extending beyond the threading 34. As shown in FIG. 8, an inner ledge 32 is disposed in the interior of the conical portion 10 at the lowermost edge of the first inner surface 24 and at the uppermost edge of the second inner surface 28.

The improved nozzle 100 is adapted for irrigation of nasal cavities and sinuses, and is adapted for connection to a fluid supply which can have a fixed pressure or can be pulsed.

The nozzle 100 is preferably composed of plastic, of a type that can be sterilized such as by placement in an autoclave or other sterilization method. The nozzle 100 can also be composed of metal, such as stainless steel or other metal adapted for use in irrigating nasal cavities and sinuses.

It is seen from the drawings and the above description that the nozzle 100 has an interior portion, and that the passages 30 communicate with the interior of the nozzle 100. The purpose of the passages 30 is to direct fluid flowing out of the nozzle 100. In use, fluid is supplied under pressure, which can be steady or can be intermittent, to the interior of the nozzle 100. The fluid flows through the passages 30 and out of the nozzle 100.

FIG. 8 is a sectional view taken along a vertical centerline of the nozzle 100 of FIG. 7, and shows the hollow interior structure of the nozzle 100. Beginning at the top, there is the generally conical inner surface 22 which expands downwardly to meet the first generally cylindrical inner surface 24. The inner ledge 32 is disposed at the lowermost end of the inner surface 24. The threaded portion 34 is formed in the second generally cylindrical inner surface 28. The threading 34 is adapted to secure the nozzle 100 to a threaded conduit (not shown) coupled to a fluid source (not shown).

As shown in FIG. 8, a centerline C a centerline indicated by the letter C is shown which is a vertical centerline of the nozzle 100. Also, a centerline indicated by the letter D passes through one of the passages 30, as shown. The centerlines C and D form an angle indicated by the letter E. In the preferred embodiment, the angle E is preferably about 45 degrees. It will be understood that the angle E can differ and still function, and can range from an angle of zero degrees to an angle of 90 degrees.

In the preferred embodiment, the passages 30 are formed as circular bores. It will be understood that the present invention is not limited to circular bores, and can instead encompass other bore shapes, including oval, flared, double-lobed, triangular, rectangular, and other shapes which would be known to anyone having skill in the nozzle arts.

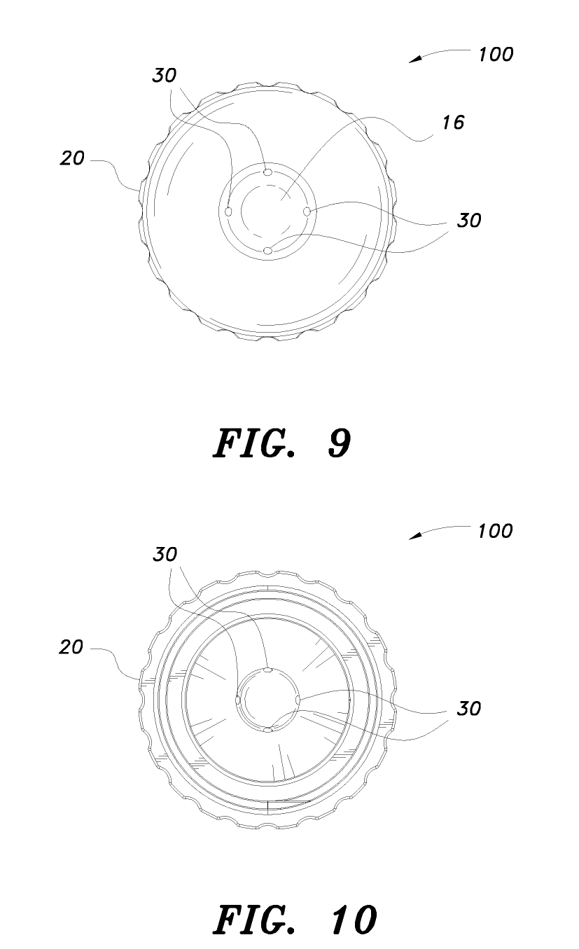

FIG. 9 is a top elevational view of the improved nozzle of FIG. 1.

FIG. 10 is a bottom elevational view of the improved nozzle of FIG. 1.

The invention being thus described, it will be evident that the same may be varied in many ways by a routineer in the applicable arts. Such variations are not to be regarded as a departure from the spirit and scope of the invention and all such modifications are intended to be included within the scope of the claims.

What is claimed is:

1. An improved nozzle for facilitating comprehensive coverage of nasal cavities and sinuses during irrigation, comprising:
a nozzle body having a conical portion and a lower portion, said nozzle body having a hollow interior;
a plurality of passages for fluid disposed in the conical portion; wherein each of said plurality of passages has a centerline disposed at specific angle relative to a centerline of said nozzle body.

2. The improved nozzle of claim 1, further comprising fluting on a lower portion of said nozzle body, to facilitate manual grasping.

3. The improved nozzle of claim 1, wherein said specific angle is about 45 degrees.

4. The improved nozzle of claim 1, wherein each passageway is formed as a bore.

5. The improved nozzle of claim 1, wherein the passageways are evenly spaced about said central axis.

6. The improved nozzle of claim 1, wherein there are four passageways.
